(19) United States
(12) Patent Application Publication
(10) Pub. No.: US 2021/0085546 A1
(43) Pub. Date: Mar. 25, 2021

(54) SympliSafer Wheelchair Footrest Cover

(71) Applicants: Janet Gifford, Fowler, KS (US); Gary Gifford, Fowler, KS (US)

(72) Inventors: Janet Gifford, Fowler, KS (US); Gary Gifford, Fowler, KS (US)

(21) Appl. No.: 16/579,838

(22) Filed: Sep. 24, 2019

(51) Int. Cl. A61G 5/12

(52) U.S. Cl. CPC A61G 5/128

(57) ABSTRACT

The present invention discloses an interlocking wheelchair foot pedal cover where the wheelchair footrest is covered to create a solid platform for additional leg and foot that can be easily attached and detached. The assembly promotes safety and prevents dragging of feet and slipping of feet between pedals once it is in motion.

### BACKGROUND

### Field of the Invention

This invention relates generally to wheelchairs and more particularly to an interlocking wheelchair footrest cover that creates a solid base to support resting the feet and to prevent slipping of feet between the pedals or dragging of the feet on the floor.

### Description of the Related Art

Leg supports of wheelchairs are generally in abutment with the front end of the seat. The thighs of the person sitting in the wheelchair rest on the seat, while the knee and the shins, together with the feet, hang down in front of the seat and are to be supported by the leg and foot support. In order to achieve a wheelchair where foot support can be added to for safety and removed when required is an essential necessity.

There are multiple inventions that have been seen in prior art in this field. For instance, a leg support for a wheelchair bearing U.S. Pat. No. 4,486,048A is issued to MEYRA KRANKENFAHRZEUG FABRIK WILHELM MEYER GmbH and Co KG. The invention discloses a leg support for a wheelchair, comprising a vertical supporting tube, which is detachably mountable on said wheelchair, the upper end of said supporting tube having a horizontal arm mounted thereon, which arm extends in the direction of travel and on which arm a leg support carrier, supporting a foot-plate and a calf-plate, is pivotably mounted by means of its upper end, in which the leg support carrier is formed by an external telescopic tube and an internal telescopic tube inserted into the external telescopic tube, both tubes being pivotably mounted on the arm about their own respective swivel axles.

Wheelchair footrest latch bearing U.S. Pat. No. 4,176,879A is issued to EVEREST AND JENNINGS Inc. The patent discloses the latch which is used to raise a downwardly biased plunger on the frame of a wheelchair normally received in an opening on a swingable footrest supporting tube to thereby release the tube and permit swinging of the wheelchair footrest to an out-of-the-way position. The latch includes a plate member cooperating with a lever such that either pressing downwardly on the lever or lifting up on the lever will release the footrest support. With this arrangement, even a severely handicapped patient can more easily operate the release than otherwise.

Wheelchair with a barrier-free footrest a U.S. Pat. No. 5,401,045A is issued to Foerster; Stephen R., Bobke; David M. The patent discloses a wheelchair including a first front wheel, a second front wheel, and a wheelchair frame having a front portion and being supported by the wheels such that the first wheel rotates about a first, generally vertical axis, the second front wheel rotates about a second, generally vertical axis, and the first and second axes are in a vertical plane adjacent the front portion.

The wheelchair also includes a footrest having a first generally vertical support member connected to the frame so that the vertical support member is substantially in the plane, a second support member connected to the first support member so that the second support member extends generally in the plane and from the first support member in a direction transverse to vertical and transverse to horizontal, and so that the second support member has an end spaced from the first support member. The wheelchair also includes a generally horizontal foot support connected to the end of the second support member and a retaining strap connected to the footrest to secure a user's foot to the foot support.

A U.S. Pat. No. 4,572,576A issued to QUADRA WHEELCHAIRS Inc is a Wheelchair with swingable foot support assemblies. The patent discloses a wheelchair having swingable foot supports which are capable of being shifted out of the way of the user to enable easy entry and exit from the wheelchair. The wheelchair generally comprises a pair of laterally spaced apart longitudinally extending side frames. At least one of these side frames and preferably both of the side frames have a main frame section. A foot support is mounted on the front frame section of each side frame and is adapted to be located in a frontal region of the wheelchair for support of the feet of the user. Individual pivot means enable the front frame sections to be angularly shifted out of the plane of the main frame sections and to carry therewith the foot supports. In this way, when the foot support member is shifted laterally, a user having a lower body disability will have easier access to and from the wheelchair. A releasable locking means is provided for normally retaining the first frame section in alignment with the main frame section e.g. generally in a co-planar relationship, when in use. The present invention also provides a foot support assembly of the type which can be used with existing wheelchairs.

A Wheelchair footrest U.S. Pat. No. 3,990,744A is issued to EVEREST AND JENNINGS Inc. The wheelchair footrest comprises a plate portion with a semi-cylindrical configuration journaling a tube in turn supported to the wheelchair such that the plate can swing from a horizontal position to a vertical position about the journaling axis. Axially slotted plastic friction sleeves surround the journaling tube in such a manner as to lock to the inner wall ends of the semi-cylindrical portion of the plate and frictionally engage the periphery of the journaling tube so that the plate is held in any set swung position.

It has to be noted that the current invention proposes an advancement in which provides a solid base for a person's feet to rest without slipping between the pedals and dragging on the floor.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of leg and foot support assembly for wheelchair.

It is another objective of the invention to provide a leg and foot support assembly which provides a solid base for a person's feet to rest.

It is further the objective of the invention to provide a leg and foot support assembly which provides anti-slip between the pedals of the wheelchair.

It is also the objective of the invention to prevent the inconvenience of dragging feet while wheelchair is in motion.

It is another objective of the invention to provide leg and foot support for people of all sizes and ages when utilizing the wheelchair.

A further object is to provide an assembly that is simple and easy to add, remove, or use.

A still further object is to provide an assembly that is economical in cost to manufacture.

It is a further object of the present invention to provide a new and improved foot support assembly for wheelchair which is of a durable and reliable construction.

Still yet another object of the present invention is to provide a new and improved foot support assembly which provides in the apparatuses and methods of the prior art some of the advantages thereof, while simultaneously overcoming some of the disadvantages normally associated therewith.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

One aspect of the present application is directed to provide a foot support assembly for the wheelchair.

More particularly the invention relates to interlocking plate covers which are put over the existing leg and footrests on a wheelchair to provide a solid base for leg and foot support. The assembly is in the form of two interlocking rectangular and hollow covers which are used over existing leg and footrests on wheelchair. The interlocking footrest cover is easily attachable and detachable and is highly portable as well.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a right side elevational view of a wheelchair showing my new design;

FIG. 2 is a front elevational view thereof;

FIG. 3 is a rear elevational view thereof;

FIG. 4 is a side elevational view thereof;

FIG. 5 is another view thereof;

FIG. 6 is a perspective view of the wheelchair.

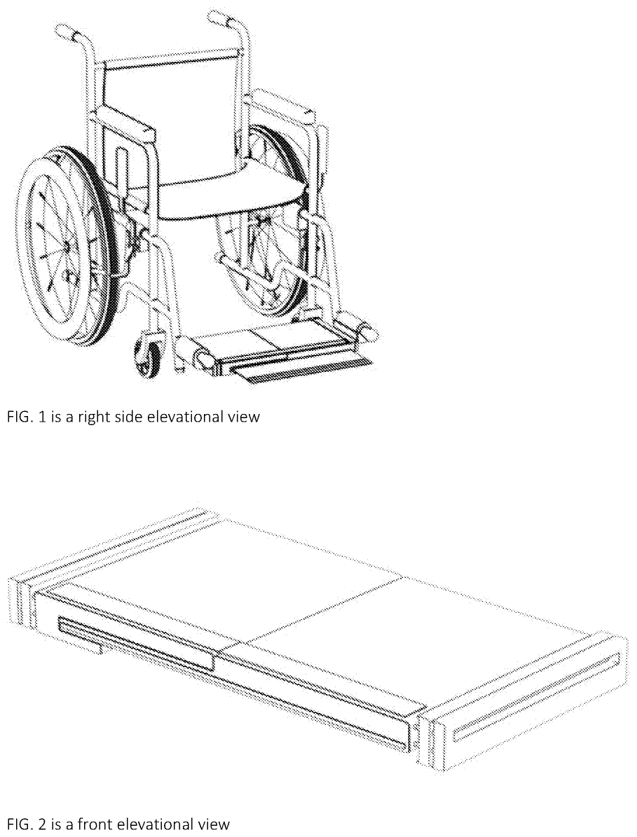

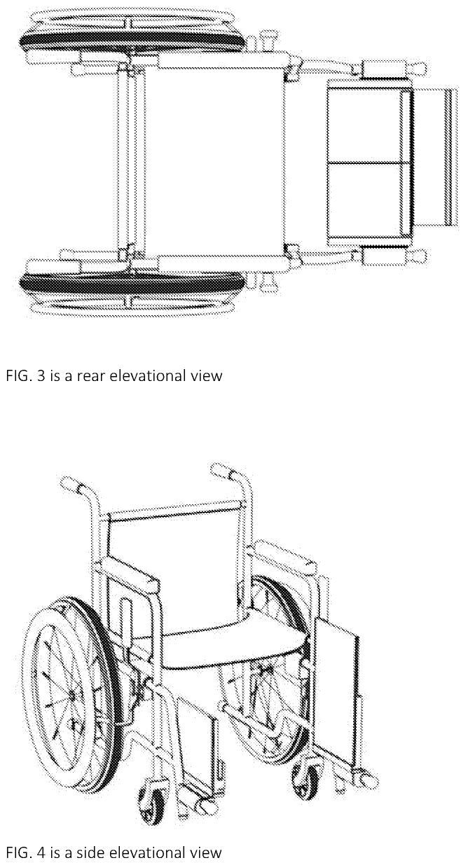

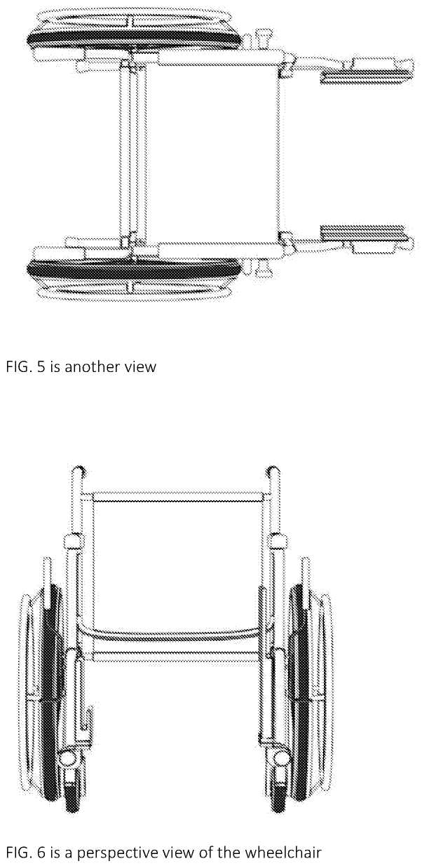

I: An interlocking wheelchair footrest cover assembly which can be attached or detached to the wheelchair footrest, allowing stable placement of feet and preventing slipping of feet between the pedals and dragging on the floor.

II: An interlocking wheelchair footrest cover where: the assembly is in form of a stronger base; the assembly can be attached or detached from the wheelchair pedals; the longer side of the interlocking assembly has an extension to allow for more space for the feet; the hollow center allows for easy installment; the arrangement is extremely simple, economical to manufacture and will not in any way scratch the other portions of the structure; the installation to any wheelchair is extremely simple and will operate reliably over a long period of time.
